(19) United States
(12) Patent Application Publication
(10) Pub. No.: US 2009/0056571 A1
(43) Pub. Date: Mar. 5, 2009

(54) STENCIL

(75) Inventor: Toni M. Schulken, Charlotte, NC (US)

Correspondence Address: THOMPSON HINE L.L.P.;Intellectual Property Group, P.O. BOX 8801, DAYTON, OH, 45401-8801, US

(73) Assignee: MEADWESTVACO CORPORATION, Glen Allen, VA (US)

(21) Appl. No.: 11/847,834

(22) Filed: Aug. 30, 2007

(51) Int. Cl. B05C 17/06

(52) U.S. Cl. 101/126

(57) ABSTRACT

A stencil system including a stencil frame having a plurality of openings formed therein for guiding the drawing of a user. The stencil system further includes a hand cue on the stencil frame for cuing a user to place the user's hand thereon to manually stabilize the stencil frame during use.

The present invention is directed to a stencil, and more particularly to a stencil with a hand cue to encourage a user to manually stabilize the stencil.

### BACKGROUND

Preschool children and others learning to draw or write may utilize tools, guides or the like to aid in their development. Such tools, guides or the like may help to develop the user's writing instrument control skills, visual motor control skills, fine motor control skills, visual perception skills and bilateral coordination skills. The development of these skills helps to advance and improve the user's writing and drawing skills.

### SUMMARY

In one embodiment the invention is a stencil system including a stencil frame having a plurality of openings formed therein for guiding the drawing of a user. The stencil system further includes a hand cue on the stencil frame for cuing a user to place the user's hand thereon to manually stabilize the stencil frame during use.

### BRIEF DESCRIPTION OF THE DRAWINGS

FIG. 1 is a top view of one embodiment of the stencil of the present invention, with a writing instrument being used in conjunction therewith;

FIG. 2 is a side cross section of the stencil of FIG. 1, taken along line 2-2;

FIG. 3 is a top view of another embodiment of the stencil of the present invention;

FIG. 4 is a side cross section of the stencil of FIG. 3;

FIG. 5 is a bottom view of the stencil of FIG. 3;

FIG. 6 illustrates a series of designs which may be made utilizing the stencil of FIG. 1;

FIG. 7 illustrates a series of sheets that may used with the stencil of the present invention; and

FIG. 8 illustrates the nine pre-writing shapes.

### DETAILED DESCRIPTION

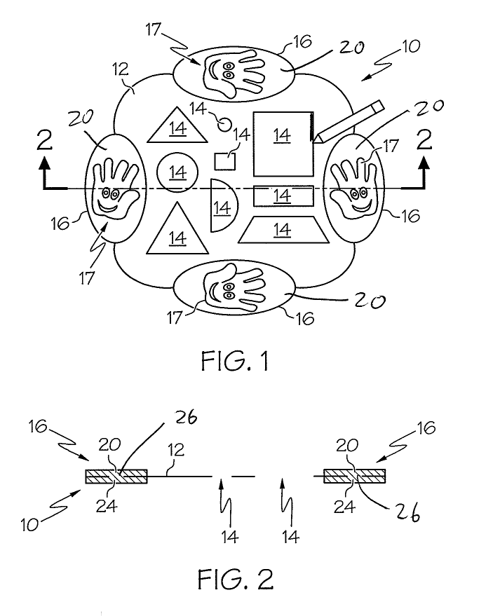

As shown in FIGS. 1-5, the stencil 10 of the present invention includes a stencil frame 12 having a plurality of openings 14 formed therein for guiding the writing/drawing of a user. The stencil frame 12 can be made of any of a wide variety of materials, such as a plastic or polymer material, and may be generally translucent to allow the user to see markings on papers or other items positioned below the stencil 10. In one embodiment, the frame 12 is between about 0.6 mm and about 2 mm thick polymer material. The frame 12 can have a variety of dimension, but in one case has a height of between about 4 inches and about 9 inches (about 6.5 inches in one case) and has a width of between about 6 inches and about 12 inches (about 9 inches in one case).

The openings 14 can take any of a wide variety of shapes, as desired. However, in one embodiment, the stencil 10 includes openings 14 that can be used to learn how to draw the basic components of at least seven of the nine “pre-writing” shapes 15. In particular, the nine pre-writing shapes 15, as shown in FIG. 8, consist of a vertical line, a horizontal line, a circle, a cross (also known more specifically as a horizontal and vertical cross), a right oblique, a square, a left oblique, an “X” (also known more specifically as an oblique cross), and a triangle. These pre-writing shapes 15 can be arranged to create all of the capital letters of the English alphabet (or the Latin alphabet) and therefore are important building blocks for a user to learn for proper capital letter formation.

As shown in FIGS. 1, 3 and 5, the openings 14 may take the form of an equilateral triangle, an isosceles triangle, a relatively small circle, a relatively large circle, a rectangle, a semi-circle, a relatively large square, a relatively small square and a trapezoid. These nine shapes teach a user to draw the horizontal lines, vertical lines, oblique lines, and curved lines necessary to construct all of the nine pre-writing shapes 15, except for the cross and oblique cross. However, the shapes of the openings 14 do teach a user the basic horizontal, vertical, right oblique and left oblique lines that constitute the cross and oblique cross (although the openings 14 do not teach the drawing of intersecting lines). Thus the openings 14 can be considered provide a user with the basic skills necessary to draw the nine pre-writing shapes 15.

For example, many children learning how to write letters have difficulty learning to draw diagonal lines which are components of the letters A, K, Y, W, X, etc. The trapezoid and triangular shaped openings 14 aid the user in drawing the oblique/diagonal lines. However, the openings 14 can take any of a variety of shapes, and need not necessarily take the form of geometric shapes, but could also take the form of alphanumeric characters.

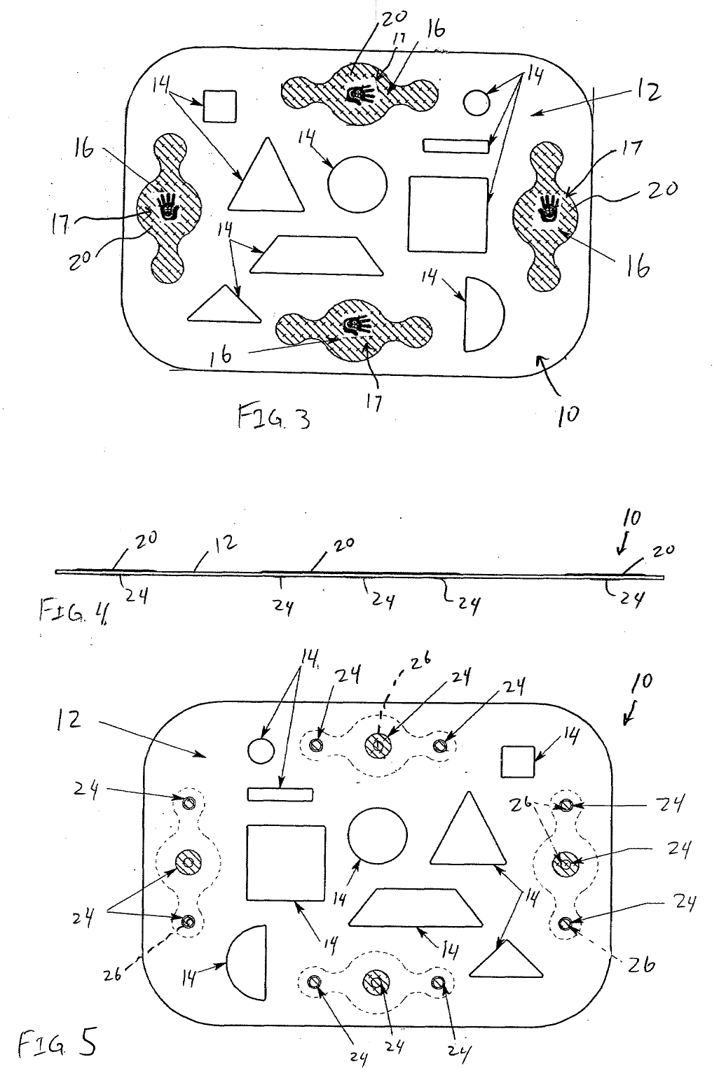

The frame 12 includes or carries thereon at least one hand cue 16 upon which a user can place his or her hand to manually stabilize the stencil frame 12 during use. Each hand cue 16 may include a support surface 20 located on an upper surface of the frame 12, and a visual cue 17 positioned on the support surface 20. In the embodiment of FIGS. 1 and 2 each support surface 20 is generally oval, and in the embodiment of FIGS. 3-5 each support surface 20 is generally shaped as a larger circle that is connected to two smaller opposed circles, although each support surface 20 can take any of a variety of shapes.

Each support surface 20 can be made of a differing material than the frame 12. In particular, in one embodiment each support surface 20 is made of a relatively soft, tactile material, such as synthetic or natural rubber or the like. The surface 20 may be made of frictional, nonskid material that is relatively soft (i.e. having a hardness of between about 20 Shore A and about 60 Shore A (about 35 Shore A in one embodiment)), and in any case may be softer than the material of the frame 12.

Thus each support surface 20 provide a soft, comfortable surface upon which a user in encouraged to place his or her hand to thereby provide proper hand placement during use of the stencil 10. The soft nature of each support surface 20 also helps to maximize surface area and gripping forces between the user's hand the support surface 20. Moreover, because each support surface 20 is tactilely distinct from the frame 12 (and non-planar with the frame 12), a user can tactilely determine when their hand is properly positioned on the hand cue 16.

Each support surface 20 can also be visually distinct from the frame 12, such as by the nature of the materials of the support surface 20, or by coloring, texturing, etc. to allow visual identification thereof. Each support surface 20 may have a surface area sufficient to support a user's hand (i.e. typically a child's hand) thereon (i.e. at least about 2 in² in one embodiment, or at least about 4 in² in another embodiment, and yet another embodiment less than about 15 in²). However, if desired the support surfaces 20 may be omitted, and each hand cue 16 can be printed directly on, or be directly supported by, the frame 12.

Each hand cue 16 may also include a stabilization surface 24 positioned on the bottom side of the frame 12. Each stabilization surface 24 may be positioned immediately below the associated visual cue 17/support surface 20 such that when a user places his or her hand on a hand cue 16, the stabilization surface 24 is pressed into frictional engagement with an underlying writing surface (i.e. desk, table or the like). The stabilization surface 24 can be made of the same materials outlined above for the support surface 20, and in any case may have a higher co-efficient friction than the frame 12. Moreover, each stabilization surface 24 may be textured on its bottom surface to improve its gripping characteristics. The stabilization surface 24 assists the user in stabilizing the stencil 10, and reduces slipping of the stencil 10 along the underlying writing surface.

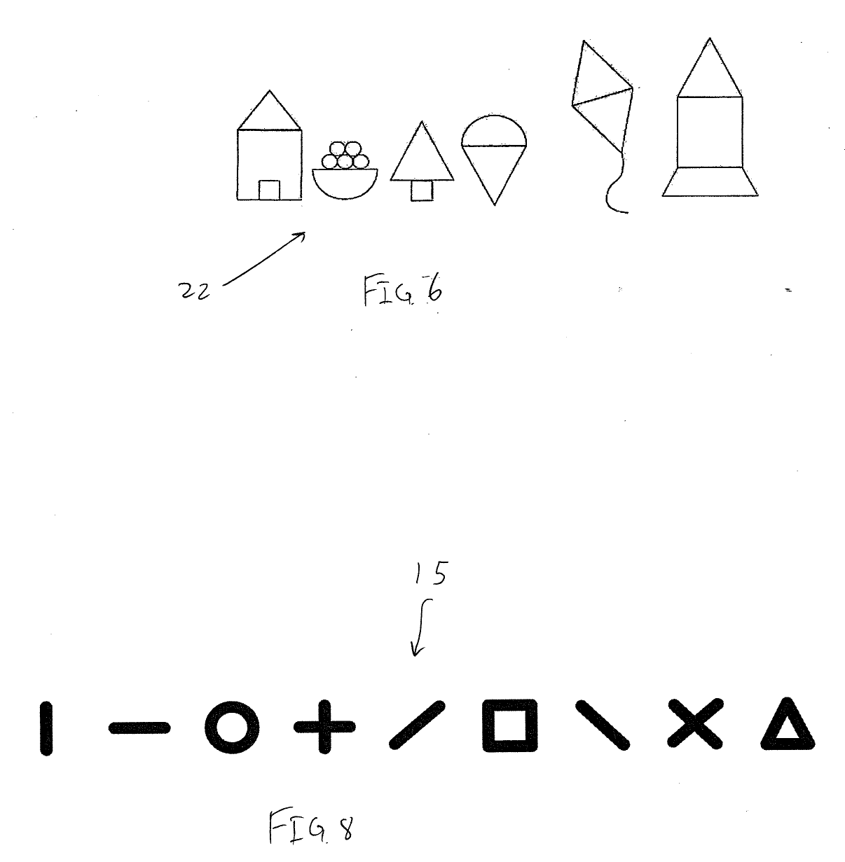

Each support surface 20 and stabilization surface 24 may be formed as part of a single molding step to form a one-piece, integrated structure. In particular, as can be seen in FIGS. 2 and 5, the frame 12 may includes holes 26 formed therethrough which allow fluid to flow therethrough during molding. The holes 26 enable the support surface 20 and stabilization surface 24 to be formed in a single molding step, thereby improving manufacturing efficiency.

In the embodiment shown in FIG. 5, each stabilization surface 24 take the form of a circle positioned through/about an associated opening 26, and three stabilization surfaces 24 are provided for each hand cue 16. In this case each stabilization surface 24 is larger than the associated hole 26 such that each stabilization surface 24 acts as a “plug” to retain the support surface 20 in place. However, the number, shape, and orientation of the stabilization surfaces 24 can vary. Moreover, the stabilization surfaces 24 may be omitted if desired.

Each visual cue 17 can be printed or otherwise formed or located on the associated support surface 20. When the support surface 20 is molded onto the frame 12, each visual cue 17 can be integrally molded into the associated support surface 20 as, for example, an embossed or depressed design that forms a single piece of material with the associated support surface 20/stabilization surface 24. In the illustrated embodiment, each visual cue 17 of takes the form of a visual representation (i.e. drawing, design, photograph or the like) of a hand to cue or encourage a user to place his or her hand on the hand cue 16. However, the visual cue 17 can take the form of other indicia besides a hand. For example some other indicia 17 (by way of example, a star, or the letter “H,” although nearly any sort of indicia can be used) may be provided on the frame 12. A user may be taught (i.e. by the stencil 10, by associated instructions/packaging, by a teacher or parent, etc.) that the indicia 17 is to be associated with hand stabilization. In this case, when a user sees the visual cue 17 the user will be prompted to stabilize the stencil 10 with his or her non-dominant (i.e. non-writing) hand.

Teachers typically have difficulty ensuring that their students properly stabilize their stencils 10 during use. Accordingly, the hand cues 16 serve as a constant reminder to the user to encourage proper stabilization and use of the stencil 10.

Each hand cue 16 may be positioned at or adjacent to the outer perimeter of the frame 12 to ensure proper hand placement. In particular, encouraging a user to place his or her stabilization hand at or adjacent to the outer edge of the frame 12 ensures that maximum stabilization force is exerted while ensuring that the stabilization hand does not interfere with drawing operations when using the stencil 10. Thus, at least part of each hand cue 16 may be located within about 3 inches of the outer edge of the frame 12, or within about 10% or 20% of the height or width of the frame 12 of the outer edge.

In the illustrated embodiment, the frame 12 is generally square or rectangular and includes four hand cues 16 equally spaced about the perimeter of the frame 12 (i.e. one hand cue 16 along each edge). Since the user may use the stencil 10 in any of a wide variety of angular orientations, placing a hand cue 16 along each edge of the frame 12 ensures that a hand cue 16 is readily available and presented for use in the various positions. Moreover, the plurality of hand cues 16 ensures that one or more hand cues 16 are sufficiently presented and available for both left-handed and right-handed users. Although the stencil 10 can take any of a variety of shapes and forms beyond the square and rectangular shapes shown herein, the hand cues 16 may be generally equally spaced and/or angularly distributed about the frame 12.

The stencil 10 may be packaged and/or sold as part of a kit with blank papers, or papers printed with designs, for use with the stencil 10. For example, FIG. 6 illustrates various designs 22 in the form of recognizable objects (i.e. a house, bowl of fruit, tree, etc.) made of shapes that correspond to the cut-outs 14 in the frame 12. The shapes 14 are arranged and/or placed adjacent to each other to cooperate to form a recognizable object. The designs 22 require a user to identify the properly-shaped opening 14 which develops visual discrimination skills and visual form constancy. Moreover, creating the designs 22 requires the user to place the shapes in the correct orientation relative to the paper and relative to other shapes, which strengthens visual spatial relationship skills. Placing the shapes adjacent to each other to complete the design 22 facilitates visual closure skills. Holding and stabilization of the stencil 10 develops hand strength and bilateral coordination. All of these skills are essential pre-requisites for legible handwriting.

In this manner a user can use the stencil 10 to draw on top of the pre-printed designs 22 on the sheets such that the designs 22 encourage and guide a user in proper stencil use. The designs 22 may, if desired, be printed in relatively thin or light lines, and/or be printed in dashed or dotted line format or the like so that a user can easily distinguish which portions of the design 22 are pre-printed and which portions have been drawn by the user.

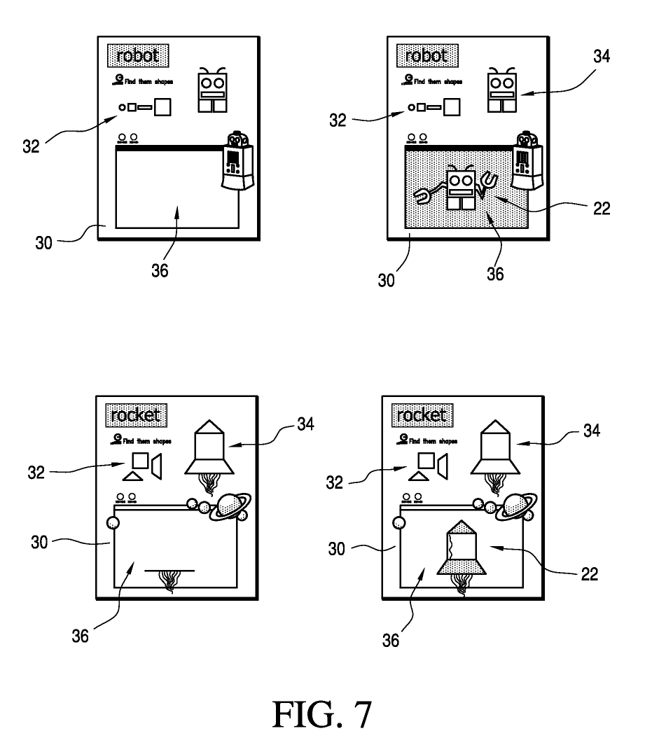

FIG. 7 illustrates a plurality of sheets 30 that can be packaged with, and used with, the stencil 10. FIG. 7 illustrates two uncompleted sheets 30, and two sheets 30 that have been completed by a user. Each sheet 30 includes a preparation area 32 which indicates which shapes 14 of the stencil 10 will be needed. Each sheet 30 also includes an instruction area 34 indicating the design 22 to be completed, and includes a drawing space 36 in which a user may draw the design 22 using the stencil 10. The stencil 10 may be packaged for sale along with a set of instructions that instruct a user (or a user's parents, teachers, etc.) to use the stencil 10 in the manner described herein.

Having described the invention in detail and by reference to the various embodiments, it should be understood that modifications and variations thereof are possible without departing from the scope of the invention.

What is claimed is:

1. A stencil system comprising:
a stencil frame having a plurality of openings formed therein for guiding the drawing of a user; and
a hand cue carried on said stencil frame for cuing a user to place the user's hand thereon to manually stabilize said stencil frame during use.

2. The stencil system of claim 1 wherein said hand cue includes a support surface positioned on an upper surface of said frame, wherein said support surface is made of a different material than said frame.

3. The stencil frame of claim 2 wherein said support surface is softer than said frame.

4. The stencil system of claim 2 wherein said support surface is made of natural or synthetic rubber.

5. The stencil frame of claim 2 wherein said hand cue is integrally molded with said support surface.

6. The stencil frame of claim 2 wherein said support surface is non-planar with said frame.

7. The stencil system of claim 1 further including a non-skid stabilization surface positioned on a bottom surface of said hand cue or said frame such that when the stencil is placed on a writing surface and a user places the user's hand on the hand cue the non-skid surface is pressed into frictional engagement with the writing surface.

8. The stencil system of claim 7 wherein said non-skid surface has a higher coefficient of friction than said frame.

9. The stencil system of claim 7 wherein said hand cue includes a support surface positioned on an upper surface of said frame, wherein said support surface and said stabilization surface are an integral one-piece material.

10. The stencil system of claim 1 wherein said hand cue includes a visual representation of a hand.

11. The stencil system of claim 1 wherein said hand cue includes indicia, and wherein said system further includes instructions that instruct a user to place the user's hand on said indicia.

12. The stencil system of claim 1 wherein said hand cue is located at or adjacent to an outer perimeter of said frame.

13. The stencil system of claim 1 wherein said hand cue has a surface area of at least about four square inches to support a child's hand thereon.

14. The stencil system of claim 1 further comprising first, second and third supplemental hand cues carried on said stencil frame, said hand cue and said supplemental hand cues being generally equally angularly spaced about said stencil frame.

15. The stencil system of claim 1 further comprising first, second and third supplemental hand cues carried on said stencil frame, said hand cue and said supplemental hand cues being generally equally spaced about a perimeter said stencil frame.

16. The stencil system of claim 1 wherein said openings include a square opening, a rectangular opening, a triangular opening, a circular opening, a semicircular opening, and a trapezoidal opening to encourage a user to acquire skills to draw pre-writing shapes.

17. The stencil system of claim 1 wherein said frame is made of a generally translucent material.

18. The stencil system of claim 1 further comprising a plurality of sheets of paper packaged with said stencil frame for use along with said stencil frame.

19. The stencil system of claim 18 wherein each sheet of paper includes a design printed thereon which is made of shapes that correspond to at least some of the shapes of said plurality of openings.

20. The stencil system of claim 1 wherein said frame is made of a polymer material.

21. A method for using a stencil system comprising:
providing a stencil having a hand cue and plurality of openings formed therein;
encouraging a user to use said plurality of opening to guide the user's drawing; and
encouraging a user to place the user's hand on the hand cue to manually stabilize said stencil during use.

22. The method of claim 21 wherein the method further includes the step of encouraging a user to utilize said plurality of openings to draw a plurality of correspondingly-shaped shapes on a sheet of paper such that the drawn shapes are positioned immediately adjacent to each other to form a recognizable object.

23. A method for using a stencil system comprising:
providing a stencil having a hand cue and a plurality of openings formed therein;
using said plurality of openings to create a plurality of markings corresponding to said openings; and
placing a hand on the hand cue to manually stabilize said stencil during said using step.
